(19) United States
(12) Patent Application Publication
(10) Pub. No.: US 2024/0237037 A9
(43) Pub. Date: Jul. 11, 2024

(54) RANDOM ACCESS RESOURCE UNITS (RA-RUs) FOR LOW-LATENCY (LL) TRAFFIC

(71) Applicant: NXP USA, Inc., Austin, TX (US)

(72) Inventors: Kiseon Ryu, San Diego, CA (US); Liwen Chu, San Ramon, CA (US); Hongyuan Zhang, Fremont, CA (US)

(21) Appl. No.: 18/482,533

(22) Filed: Oct. 6, 2023

Related U.S. Application Data
(60) Provisional application No. 63/380,360, filed on Oct. 20, 2022.

(51) Int. Cl. H04W 72/512; H04W 74/08

(52) U.S. Cl. CPC H04W 72/512; H04W 74/085; H04W 84/12

(57) ABSTRACT

One example discloses a method for low-latency (LL) traffic frame communication between WLAN (wireless local area network) devices, including: sending a trigger frame from an access point (AP) configured to allocate a random access resource unit (RA-RU) to a non-access point station (non-AP STA); wherein the RA-RU enables the non-AP STA to transmit its low latency (LL) traffic information; and receiving, from the non-AP STA, an uplink LL traffic frame using the RA-RU that was allocated.

### REFERENCE TO PROVISIONAL APPLICATION TO CLAIM PRIORITY

A priority date for this present U.S. patent application has been established by prior U.S. Provisional Patent Application, Ser. No. 63/380,360, entitled “UL OFDMA random access for low latency traffic”, filed on Oct. 20, 2022, and commonly assigned to NXP USA, Inc.

The present specification relates to systems, methods, apparatuses, devices, articles of manufacture and instructions for low-latency (LL) traffic.

### SUMMARY

According to an example embodiment, a method for low-latency (LL) traffic frame communication between WLAN (wireless local area network) devices, comprising: sending a trigger frame from an access point (AP) configured to allocate a random access resource unit (RA-RU) to a non-access point station (non-AP STA); wherein the RA-RU enables the non-AP STA to transmit its low latency (LL) traffic information; and receiving, from the non-AP STA, an uplink LL traffic frame using the RA-RU that was allocated.

In another example embodiment, the RA-RU is configured to be used only for uplink LL traffic frame transmission.

In another example embodiment, the RA-RU allocated is unavailable for non-LL traffic frames.

In another example embodiment, further comprising, announcing, by the AP, the RA-RU periodic allocation in a broadcast management frame.

In another example embodiment, further comprising: establishing, between the non-AP STA and the AP, a membership group by exchanging management frames; wherein the membership group is associated with the RA-RU; and transmitting, by the non-AP STA, a LL traffic frame on the RA-RUs assigned to the membership group.

In another example embodiment, further comprising: transmitting, by the non-AP STA, an LL traffic frame by selecting the RA-RU without random backoff when the non-AP STA receives the trigger frame.

In another example embodiment, the trigger frame is an Uplink OFDMA Random Access (UORA) Mode random access trigger frame (TF-R).

In another example embodiment, the trigger frame is included in a MU PPDU downlink (DL) data frame.

In another example embodiment, the LL information includes an LL traffic frame.

In another example embodiment, the LL information includes a buffer status report frame including buffered LL traffic frames pending uplink.

In another example embodiment, the AP holds a transmission opportunity (TXOP).

In another example embodiment, the non-AP STA holds a transmission opportunity (TXOP).

In another example embodiment, the non-AP STA is a first non-AP STA; further comprising, receiving, by the AP, a Reverse Direction Grant (RDG) from the non-AP STA TXOP holder; and sending the trigger frame from the access point (AP) to allocate the RA-RU to a second non-AP STA for LL traffic frame transmission.

In another example embodiment, the non-AP STA is a first non-AP STA; the AP has a TXOP preemption interval overlapping the TXOP held by the first non-AP STA; and further comprising, sending the trigger frame from the access point (AP) to allocate the RA-RU to a second non-AP STA for LL traffic frame transmission.

In another example embodiment, further comprising: defining a new Uplink OFDMA Random Access (UORA) parameter set for LL traffic frame transmissions that differs from standard UORA parameter sets.

In another example embodiment, further comprising: defining a new Uplink OFDMA Random Access (UORA) backoff procedure for LL traffic frame transmissions that differs from standard UORA backoff procedures.

In another example embodiment, the new UORA backoff procedure prevents the non-AP STA from performing OFDMA random backoff, OBO count selection based on an OCW, and OBO count decrement based on a number of the RA-RUs allocated.

In another example embodiment, further comprising: polling, by the AP, to check if the non-AP STA has any buffered LL traffic by sending an NFRP (NDP Feedback Report Poll) trigger frame to the non-AP STA that is specific to LL traffic frame transmissions.

In another example embodiment, further comprising: receiving an LL Indication (LLI) frame, by the AP, from the non-AP STA; and sending, by the AP, the trigger frame allocating the RA-RUs for the non-AP STA's LL traffic frame transmissions in response to receiving the LLI frame.

In another example embodiment, the non-AP STA is configured to send the LLI frame in response to receiving from the AP an LLI Allowance frame indicating that LLI frames are allowed.

According to an example embodiment, a method for low-latency (LL) traffic frame communication between WLAN (wireless local area network) devices, comprising: receiving a trigger frame from an access point (AP) configured to allocate a random access resource unit (RA-RU) to a non-access point station (non-AP STA); wherein the RA-RU enables the non-AP STA to transmit its low latency (LL) traffic information; transmitting, by the non-AP STA, an uplink LL traffic frame using the RA-RU that was allocated.

In another example embodiment, the RA-RU is configured to be used only for uplink LL traffic frame transmission.

In another example embodiment, further comprising: announcing, by the AP, a periodic allocation of RA-RUs in a broadcast management frame.

In another example embodiment, further comprising: establishing, between the non-AP STA and the AP, a membership group by exchanging management frames; wherein the membership group is associated with the RA-RU; and transmitting, by the non-AP STA, an LL traffic frame on the RA-RUs assigned to the membership group.

In another example embodiment, further comprising: transmitting, by the non-AP STA, an LL traffic frame by selecting the RA-RU without random backoff when the non-AP STA receives the trigger frame.

The above discussion is not intended to represent every example embodiment or every implementation within the scope of the current or future Claim sets. The Figures and Detailed Description that follow also exemplify various example embodiments.

Various example embodiments may be more completely understood in consideration of the following Detailed Description in connection with the accompanying Drawings.

### BRIEF DESCRIPTION OF THE DRAWINGS

FIG. 1 represents a first example wireless communications network (WLAN).

FIG. 2 represents example traffic frame exchanges for an Uplink OFDMA Random Access (UORA) Mode in IEEE-802.11ax.

FIG. 3A represents example traffic frame exchanges between an AP TXOP holder and a non-AP STA (STA1) that blocks low-latency (LL) traffic frames buffered by another non-AP STA (STA2).

FIG. 3B represents example traffic frame exchanges between the AP and the non-AP STA (STA1) TXOP holder that also blocks the LL traffic frames buffered by the another non-AP STA (STA2).

FIG. 4A represents a first instance of a first example protocol for enabling transmission of buffered LL traffic frames.

FIG. 4B represents a second instance of the first example protocol for enabling transmission of buffered LL traffic frames.

FIG. 5 represents an instance of a seventh example protocol for enabling transmission of buffered LL traffic frames.

FIG. 6 represents an instance of a tenth example protocol for enabling transmission of buffered LL traffic frames.

While the disclosure is amenable to various modifications and alternative forms, specifics thereof have been shown by way of example in the drawings and will be described in detail. It should be understood, however, that other embodiments, beyond the particular embodiments described, are possible as well. All modifications, equivalents, and alternative embodiments falling within the spirit and scope of the appended claims are covered as well.

### DETAILED DESCRIPTION

IEEE (Institute of Electrical and Electronics Engineers) 802 defines communications standards for various networked devices (e.g., Local Area Networks (LAN), Metropolitan Area Networks (MAN), etc.). IEEE 802.11 further defines communications standards for Wireless Local Area Networks (WLAN). As such, communications on these networks must, by agreement, follow one or more communications protocols (i.e. be standards compliant) so that various network devices can communicate. These protocols are not static and are modified (e.g., different generations) over time, typically to improve communications robustness and increase throughput.

In embodiments of a wireless communication network described below, a wireless communications device such as an access point (AP) of a wireless local area network (WLAN) transmits data streams to one or more client stations (STAs). The AP and STAs communicate using one or more communication protocols. These protocols may include IEEE protocols such as: 802.11b; 802.11g; 802.11a; 802.11n [i.e. HT (High Throughput) with Single-User Multiple-Input Multiple-Output (SU-MIMO)]; 802.11ac [i.e. VHT (Very High Throughput) with downlink Multi-User MIMO (MU-MIMO)]; 802.11ax [i.e. HE (High Efficiency) operating at both 2.4- and 5-GHz bands, including OFDMA (Orthogonal Frequency Division Multiple Access) and MU-MIMO with uplink scheduling]; and 802.11be [i.e. EHT (Extra High Throughput) operating at 2.4 GHz, 5 GHz, and 6 GHz frequency bands and a much wider 320 MHz bandwidth].

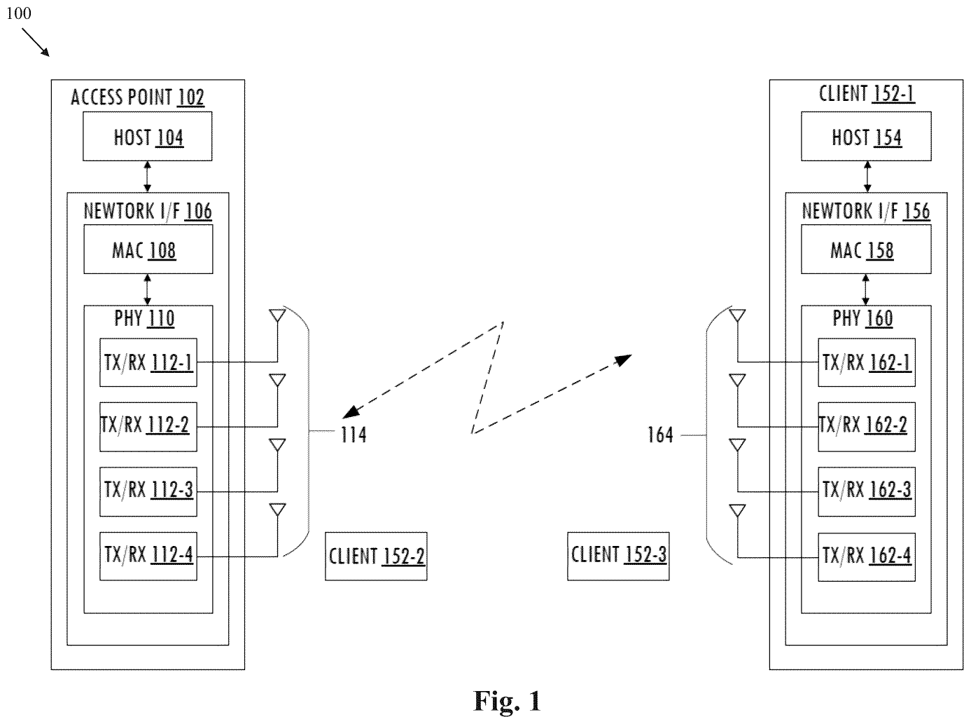

FIG. 1 represents a first example 100 wireless communications network (WLAN) formed by a first set of wireless communications devices (i.e. AP STAs and Client-STAs). The WLAN 100 includes access point station (AP STA) 102 and a set of non-AP stations (non-AP/Client STAs) 152-1, 152-2, and 152-3.

The AP 102 includes host processor 104 (e.g., controller) coupled to network interface 106. Host processor 104 includes a processor configured to execute machine readable instructions stored in a memory device (not shown), e.g., random access memory (RAM), read-only memory (ROM), a flash memory, or other storage device.

Network interface 106 includes medium access control (MAC) processor 108 and physical layer (PHY) processor 110. In some example embodiments the MAC processor 108 operates at the data-link layer of the OSI (Open Systems Interconnection) model and the PHY processor 110 operates at the physical layer of the OSI model.

The PHY processor 110 includes a plurality of transceivers 112-1, 112-2, 112-3, and 112-4, each of which is coupled to a corresponding antenna of antennas 114. These antennas 114 can support MIMO functionality. Each of transceivers 112-1, 112-2, 112-3, and 112-4 includes a transmitter signal path and a receiver signal path, e.g., mixed-signal circuits, analog circuits, and digital signal processing circuits for implementing radio frequency and digital baseband functionality. The PHY processor 110 may also include an amplifier (e.g., low noise amplifier or power amplifier), a data converter, and circuits that perform discrete Fourier transform (DFT), inverse discrete Fourier transform (IDFT), modulation, and demodulation, thereby supporting OFDMA modulation.

The client STAs 152-1, 152-2, and 152-3 each include similar circuits (e.g., host processor 154 (e.g., controller), network interface 156, MAC processor 158, PHY processor 160, transceivers 162-1, 162-2, 162-3, and 162-4, and antennas 164) that provide similar functionality to that of AP 102 but are adapted to client-side specifications.

The MAC 108, 158 and PHY 110, 160 processors within the AP 102 and STA 152-1 exchange PDUs (Protocol Data Units) and SDUs (Service Data Units) in the course of managing the wireless communications traffic. The PHY processor is configured to receive MAC layer SDUs, encapsulate the MAC SDUs into a special PDU called a PPDU (physical layer protocol data units) by adding a preamble.

The preamble (i.e. TXVECTOR, transmission vector) specifies the PPDU's transmission format (i.e. which IEEE protocol (e.g., EHT, HE, etc.) has been used to pack the SDU data payload). The PPDU preambles may include various training fields (e.g., predetermined attributes) that are used by the receiving APs or STAs to perform synchronization, gain control, estimate channel characteristics, and signal equalization. The AP 102 and STA 152-1 then exchange the PPDU formatted wireless communications signals 116.

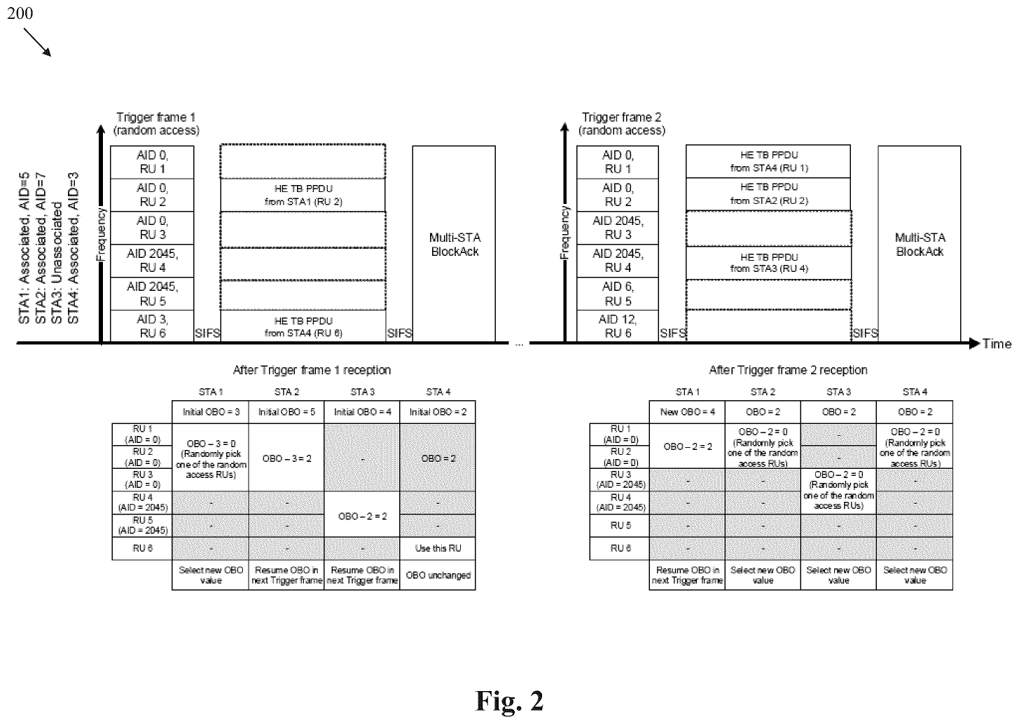

FIG. 2 represents example traffic frame exchanges 200 for an Uplink OFDMA Random Access (UORA) Mode in IEEE-802.11ax. UORA Mode facilitates packet transmissions from STAs while MU (multi-user) OFDMA transmissions from other STAs are in progress.

UORA Mode is initiated when the AP transmits a trigger frame random access (TF-R) (e.g. trigger frame 1) with at least one resource unit (RU) reserved for RA assigned to association identifier (AID)=0 for associated STAs, and to AID 2045 for unassociated STAs.

Contending STAs maintain four contention parameters: an OFDMA Contention Window (OCW); a minimum OCW (OCWmin); a maximum OCW (OCWmax); and an OFDMA backoff counter (OBO).

The OBO is picked uniformly in [0, OCW−1]. The TF-R allocates a subset of the total RUs for RA (AID=0). When contending STAs receive TF-R, they decrement their respective OBO by number of RA-RU. If the OBO of a particular STA reaches 0, then it picks one of the RUs allocated for RA at random and transmits its traffic frame after SIFS (short inter frame space).

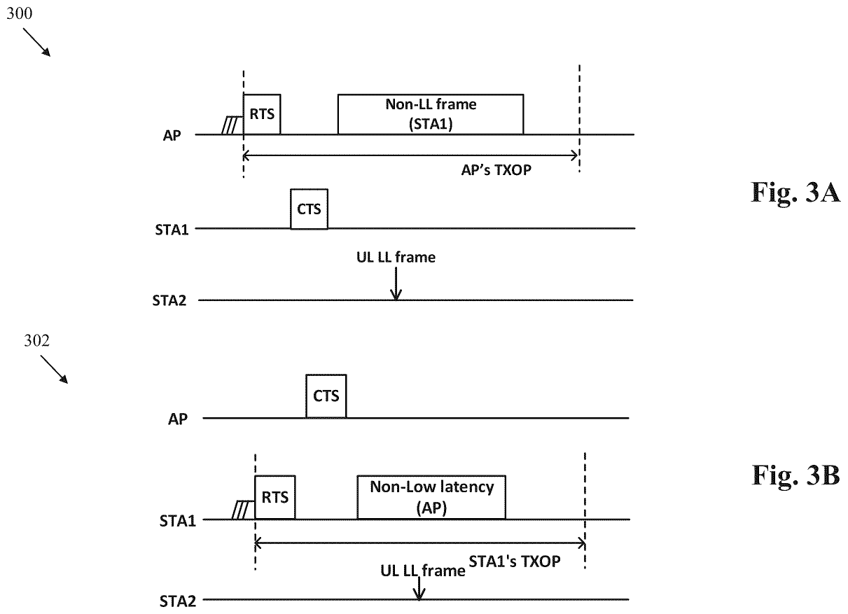

FIG. 3A represents example traffic frame exchanges 300 between an AP TXOP holder and a non-AP STA (STA1) that blocks low-latency (LL) traffic frames buffered by another non-AP STA (STA2). FIG. 3B represents example traffic frame exchanges 302 between the AP and the non-AP STA (STA1) TXOP holder that also blocks the LL traffic frames buffered by the another non-AP STA (STA2).

Even with the UROA Mode described above, a non-AP STA's buffered low latency (LL) traffic frames may often not be timely transmitted to the AP, particularly when TXOP (transmission opportunity) windows are held by either the AP or other non-AP STAs.

Normally a non-AP STA sets a non-zero intra-BSS (basic service set) NAV (network allocation vector) by receiving an intra-BSS PPDU; however, due to the non-zero intra-BSS NAV, the non-AP STA cannot transmit its buffered LL traffic frames until an end of the TXOP, unless the AP sends the TF-R trigger frame to the non-AP STA requesting uplink (UL) transmission of any LL traffic frames.

However in many instances, the AP does not send the TF-R to the non-AP STA since the AP has no knowledge about LL traffic frames buffered at the non-AP STA.

Now discussed are various protocols for using random access resource units (RA-RUs) to enable non-TXOP holding non-AP STAs to transmit their buffered LL frames.

First example protocol (e.g. proposal 1) for enabling low-latency (LL) frame communication between WLAN (wireless local area network) devices. During a DL TXOP, an AP should allocate using a trigger frame 402 (e.g. an Uplink OFDMA Random Access (UORA) Mode random access trigger frame (TF-R)) at least one or more RA-RUs for non-AP STAs to transmit their uplink LL traffic frames 404 and/or a buffer status report frame related to their buffered LL traffic frames using the RA-RUs.

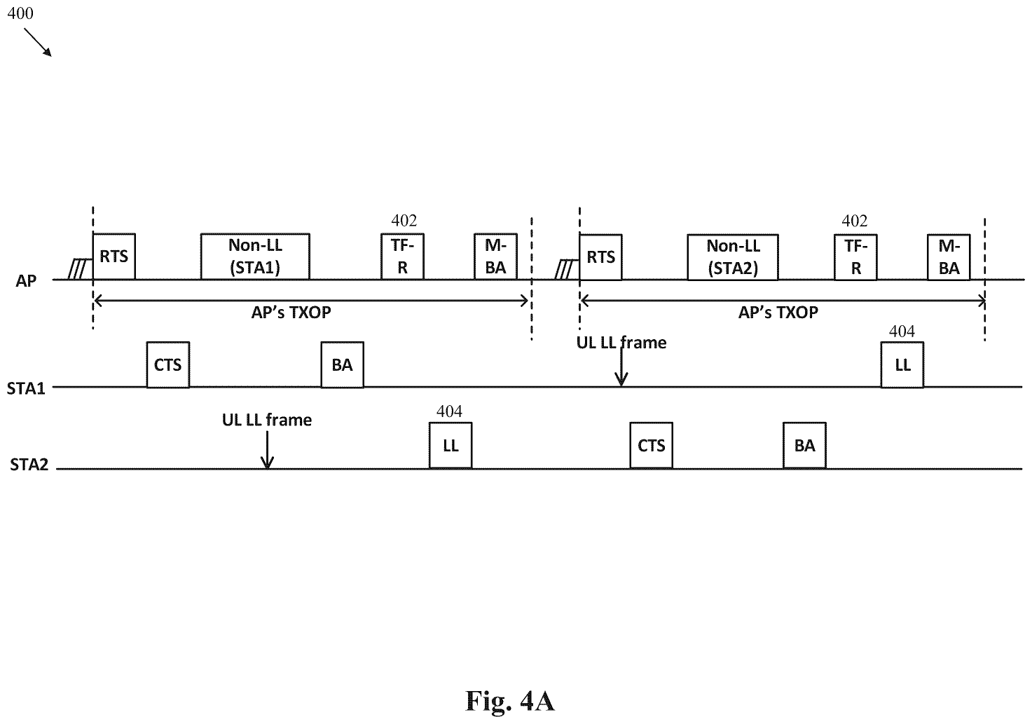

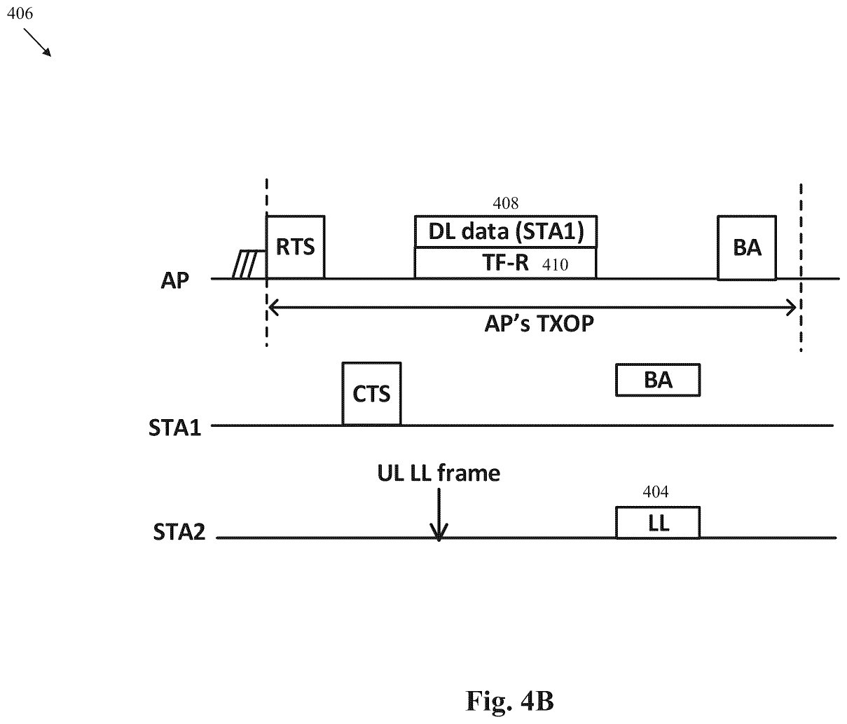

FIG. 4A represents a first instance 400 of the first example protocol for enabling transmission of buffered LL traffic frames. If an AP obtains a TXOP (e.g., DL TXOP), the AP should allocate at least one RA-RU using the TF-R trigger frame during the TXOP. Additional condition may include the DL TXOP length threshold (e.g., 3 ms, 5 ms, etc.) can be defined for RA-RU allocation using the TF-R trigger frame during the DL TXOP.

A non-AP STA (e.g. STA2 in the first AP TXOP as shown on the left side of FIG. 4A, and STA1 in the second AP TXOP as shown on the right side of FIG. 4A) that has a buffered LL traffic frame and receives the TF-R trigger frame may transmit the LL traffic frame using the RA-RU allocated by the trigger frame.

In another example, an AP may allocate at least one RA-RUs during a DL TXOP when any of associated non-AP STAs have exchanged with the AP an action/management frame specifying a traffic stream associated with LL requirement or capabilities about random access support for LL traffic

FIG. 4B represents a second instance 406 of the first example protocol for enabling transmission of buffered LL traffic frames. A MU PPDU downlink (DL) data frame 408 includes a trigger frame 410 (i.e. TF-R) allocating one or more RA-RUs for the LL traffic frames in an RU. Trigger frame 410 is a separate individually addressed trigger frame allocating UL resource for acknowledgement (BA) frame transmission from one or more intended receiver aggregated with a DL data frame in an A-MPDU in another RU of the DL MU PPDU.

In some example embodiments, a PHY header (e.g., SIG field) of DL PPDU may indicate the LL RA-RU allocation followed by the DL PPDU. The PHY header (e.g., SIG field) may also indicate a trigger frame inclusion allocating the LL RA-RU.

An intended receiver non-AP STA (i.e. STA1) of DL data frame transmits an acknowledgement frame (e.g., Ack, BA, M-BA, etc.,) in a trigger-based (TB) PPDU. An unintended receiver non-AP STA (i.e. STA2) of DL data frame that has a LL traffic frame may transmit the LL traffic frame in a trigger-based (TB) PPDU using the allocated RA-RU followed by the DL PPDU.

Second example protocol (e.g. proposal 2) for enabling low-latency (LL) frame communication between WLAN (wireless local area network) devices. Here dedicated RA-RUs (e.g., LL RA-RUs) that can only be used for LL traffic frame transmission or for transmission of the buffer status report (BSR) frame for LL traffic are allocated by the TF-R. The TF-R trigger frame includes an indication of the allocated RA-RU to be used only for transmission of the PPDU including the LL traffic frame or the BSR frame for LL traffic. The indication can be specified in the TF-R trigger frame by one or more traffic identifiers (TIDs) or one or more access categories (ACs) that are allowed to be transmitted using the allocated RA-RU. A Non-AP STA that intends to transmit a non-LL traffic frame cannot access the channel using the LL RA-RU.

The LL traffic frame only indication can be defined with a unique specific AID value (e.g., 2044, or 2047, etc.) in the AID12 subfield in the trigger frame. Non-AP STAs that intend to transmit the LL traffic frame may contend to access the channel using the LL RA-RU. If one or more LL RA-RUs are allocated, a non-AP STA that intends to transmit the LL traffic frame or the BSR frame for LL traffic using the LL RA-RUs may use not a non-LL RA-RU to transmit the LL traffic frame but must use the LL RA-RUs (e.g., the non-AP STA does not decrease its OBO count based on non-LL RA-RU if any). The AP may announce existence of the LL RA-RU allocation by a broadcast management frame (e.g., Beacon, Probe Response, etc.).

Third example protocol (e.g. proposal 3) for enabling low-latency (LL) frame communication between WLAN (wireless local area network) devices. In this example embodiment, the AP announces a periodic allocation of RA-RUs in a broadcast management frame (e.g., Beacon frame).

The periodic allocation of RA-RUs may be used only for transmission of the PPDU including the LL traffic frame. The periodic allocation of RA-RUs may be signaled using a modified TWT element that includes information about a target allocation time, a periodicity, etc. In order to allocate the periodic RA-RUs, an AP may transmit a trigger frame allocating the RA-RUs at the time indicated in the broadcast management frame if the channel is idle (e.g., based on PHY and/or virtual carrier sense). A non-AP STA may transmit any LL traffic frames using the periodic RA-RUs according to normal UORA procedures or using the LL RA-RUs described above.

Fourth example protocol (e.g. proposal 4) for enabling low-latency (LL) frame communication between WLAN (wireless local area network) devices. In this example embodiment, the non-AP STA negotiates with an AP a membership group associated with the RA-RUs for the LL traffic frames so that group member non-AP STAs can transmit a LL traffic frame using an RA-RU assigned to the membership group.

Random access procedures for LL traffic frame transmission may be based on a membership group. In order to access the channel using an RA-RU assigned to the membership group (e.g., membership group for LL support), a non-AP STA may exchange management/action frames with an AP to join the membership group and to negotiate the related parameters (e.g., group ID, periodicity of RA-RU allocation, etc.).

In some example embodiments, the TF-R trigger frame allocating the RA-RUs may include a group identifier indicating which group members can use the allocated RA-RUs. In other example embodiments, a broadcast management frame (e.g., Beacon) may include a group identifier indicating which group members' RA-RU will be allocated.

Fifth example protocol (e.g. proposal 5) for enabling low-latency (LL) frame communication between WLAN (wireless local area network) devices. In this example embodiment, the AP defines a new Uplink OFDMA based Random Access (UORA) parameter set for LL traffic frame transmissions that differs from standard UORA parameter set's (e.g. OCWmin, OCWmax, etc. values).

When a non-AP STA transmits an LL traffic frame using the RA-RUs allocated, the non-AP STA may use these new UORA parameters configured for LL traffic frame transmissions. In some example embodiments, the AP may announce multiple UORA parameter sets including those for both LL traffic frame transmissions as well as those for non-LL traffic frame transmissions.

Sixth example protocol (e.g. proposal 6) for enabling low-latency (LL) frame communication between WLAN (wireless local area network) devices. In this example embodiment, the AP defines a new UORA backoff procedure for LL traffic frame transmissions or for LL traffic related BSR frame transmission that differs from standard UORA backoff procedures.

A non-AP STA may transmit a LL traffic frame or a BSR frame for LL traffic by selecting one of RA-RUs randomly once it receives a trigger frame allocating one or more RA-RUs.

When any RA-RU is assigned, the non-AP STA may perform only the random selection. The non-AP STA selects one of allocated RA-RU randomly and it transmits the LL traffic frame or a BSR frame for LL traffic using the randomly selected RA-RU.

The non-AP STA may not perform the OFDMA random backoff. For example, no OBO count selection based on the OCW, and no OBO count decrement based on the number of the RA-RU.

If an AP fails to receive the LL traffic frame on the RA-RU selected due to a collision by more than one non-AP STAs transmissions, the AP may allocate RA-RUs using a second trigger frame PIFS after a first trigger frame for the non-AP STAs retransmission of the LL traffic frame.

If a non-AP STA transmitting a LL traffic frame using an RA-RU allocated in the first trigger frame and not receiving an acknowledgment frame receives the second trigger frame allocating RA-RUs for LL traffic frame transmission, the non-AP STA selects randomly one of the RA-RUs allocated in the second trigger frame and it retransmits the LL traffic frame using the selected RA-RU without performing the exponential backoff procedure.

The second trigger frame may include an indication that the allocated RA-RUs are only for retransmission of the LL traffic frame.

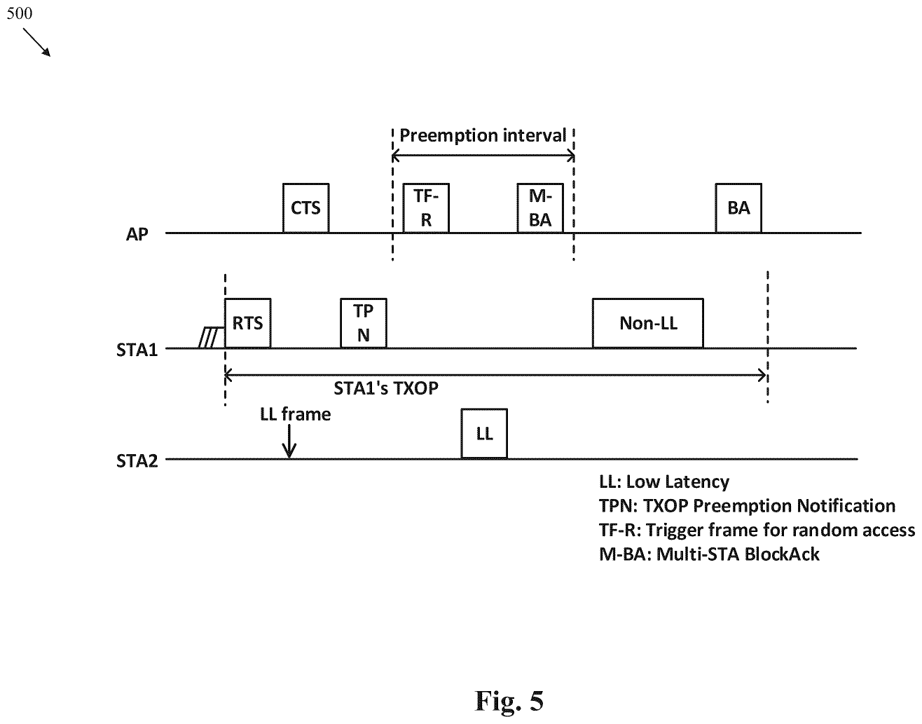

Seventh example protocol (e.g. proposal 7) for enabling low-latency (LL) frame communication between WLAN (wireless local area network) devices. FIG. 5 represents an instance 500 of the seventh example protocol for enabling transmission of buffered LL traffic frames.

In some example embodiments, during an UL TXOP (e.g. STA1 holds the TXOP, as shown in FIG. 5), if the AP is given a shared TXOP by the non-AP STA TXOP holder or the AP has a transmission time period (e.g. TXOP preemption interval), the AP may transmit the TF-R trigger frame to allocate the RA-RUs for LL traffic frame transmission or for LL traffic related BSR frame transmission from other non-TXOP holding non-AP STAs (e.g. STA2 in FIG. 5).

In other example embodiments, the AP may request the transmission time period (e.g. TXOP preemption interval) from the TXOP holder (e.g. STA1) to allocate the RA-RUs for the other non-AP STAs (e.g. STA2) to transmit either their LL traffic frames or a buffer status report frame indicating their buffered LL traffic frames.

This may be performed based on a timer wherein the AP may allocate at least one RA-RU before expiration of the timer. A non-AP STA may transmit a LL traffic frame using the allocated RA-RU.

Eighth example protocol (e.g. proposal 8) for enabling low-latency (LL) frame communication between WLAN (wireless local area network) devices. In this example embodiment, the AP polls a non-AP STA's LL traffic requirements by transmitting an NFRP (NDP Feedback Report Poll) trigger frame that is specific to LL traffic frame transmission needs.

In some example embodiments, the NFRP trigger frame can be used to check if any non-AP STA has a buffered LL traffic. For example, an AID subfield in the NFRP trigger frame set to a specific value (e.g., 2044, or 2047, etc.) can be used. Non-AP STA that has a buffered LL traffic frame and receives the NFRP trigger frame with the AID set to the specific value may transmit an NDP feedback set to true. If an AP receives the NDP feedback set to true from any non-AP STA, the AP may transmit a TF-R frame allocating the LL RA-RUs

In other example embodiments, the NFRP trigger frame can be used to check if a specific non-AP STA has a buffered LL traffic. AID12 subfield in the NFRP trigger frame set to an AID of a non-AP STA can be used. Non-AP STA that has a buffered LL traffic frame and receives the NFRP trigger frame with the AID12 set to the AID of the non-AP STA may transmit an NDP feedback set to true.

If an AP receives the NDP feedback set to true from the non-AP STA, the AP may transmit either a Basic trigger frame to trigger transmission of the LL traffic frame from the non-AP STA or a BSRP trigger frame to trigger transmission of the BSR frame for LL traffic from the non-AP STA. The NFRP trigger frame can include an indication of that an NDP feedback is transmitted only for enabling LL traffic frame transmissions.

Ninth example protocol (e.g. proposal 9) for enabling low-latency (LL) frame communication between WLAN (wireless local area network) devices. To support the various protocols/proposals described herein, the AP and the non-AP STAs may be configured to negotiate the various capabilities and/or operational parameters described herein using one or more management frames (e.g., association request/response frame) or one or more action frames.

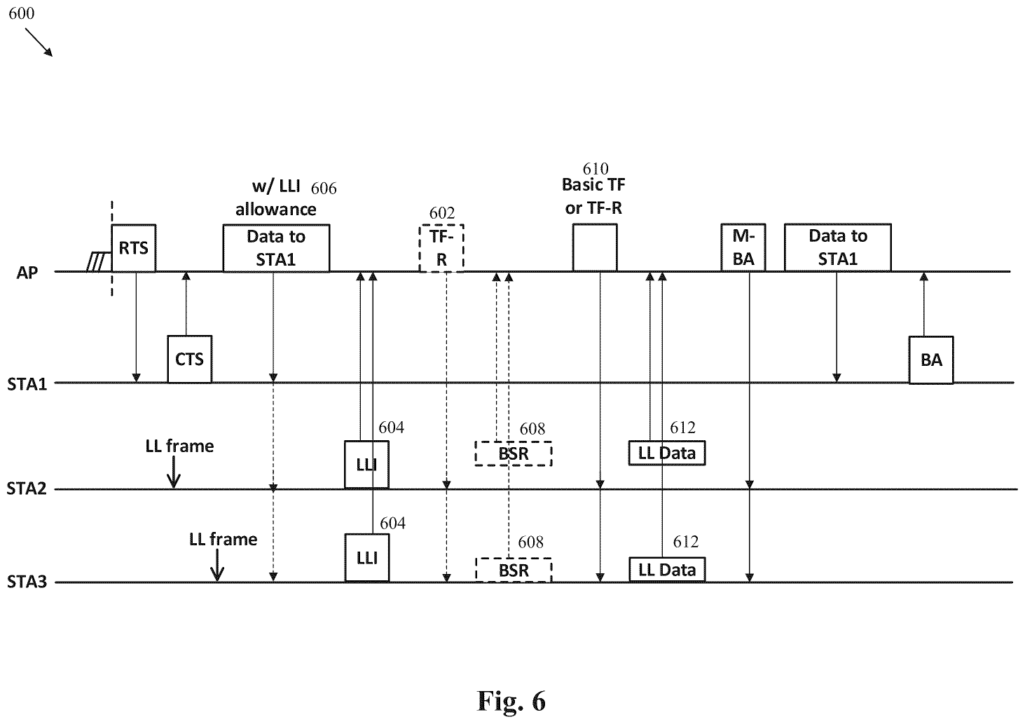

Tenth example protocol (e.g. proposal 10) for enabling low-latency (LL) frame communication between WLAN (wireless local area network) devices. FIG. 6 represents an instance 600 of the tenth example protocol for enabling transmission of buffered LL traffic frames.

In this example embodiment, the AP sends a TF-R trigger frame 602 allocating the RA-RU for LL traffic frame transmissions in response to receiving an LL Indication (LLI) frame 604 from one or more of the non-AP STAs (e.g. STA1 or STA2). The LLI frames 604 are transmitted by non-AP STAs that have buffered LL traffic frames after receiving from the AP an LLI Allowance frame 606 indicating that the LLI frames 604 are allowed. The LLI frames 604 can be transmitted in a non-HT PPDU or a non-HT duplicate PPDU having a unified frame format.

In some example embodiments, the allocated RA-RUs can be used only by the non-AP STAs that sent the LLI frame 604, to transmit their buffer status report frames or their buffered LL traffic frames to the AP. In an example embodiment, the AP may transmit a buffer status report poll (BSRP) trigger frame 602 indicating one or more RA-RUs upon receiving of the LLI frame. If the AP receives one or more buffer status report (BSR) frames 608 from each non-AP STA, then the AP can transmit a Basic trigger frame 610 to schedule uplink transmission for LL traffic frames 612 from the one or more non-AP STAs that sent the buffer status report frames. In another example embodiment, upon receiving of the LLI frame 604, the AP may transmit a Basic trigger frame 610 indicating one or more RA-Rus to schedule uplink transmission for LL traffic frames 612 from the one or more non-AP STAs that sent the LLI frames.

Various instructions and/or operational steps discussed in the above Figures can be executed in any order, unless a specific order is explicitly stated. Also, those skilled in the art will recognize that while some example sets of instructions/steps have been discussed, the material in this specification can be combined in a variety of ways to yield other examples as well, and are to be understood within a context provided by this detailed description.

In some example embodiments these instructions/steps are implemented as functional and software instructions. In other embodiments, the instructions can be implemented either using logic gates, application specific chips, firmware, as well as other hardware forms.

When the instructions are embodied as a set of executable instructions in a non-transitory computer-readable or computer-usable media which are effected on a computer or machine programmed with and controlled by said executable instructions. Said instructions are loaded for execution on a processor (such as one or more CPUs). Said processor includes microprocessors, microcontrollers, processor modules or subsystems (including one or more microprocessors or microcontrollers), or other control or computing devices. A processor can refer to a single component or to plural components. Said computer-readable or computer-usable storage medium or media is (are) considered to be part of an article (or article of manufacture). An article or article of manufacture can refer to any manufactured single component or multiple components. The non-transitory machine or computer-usable media or mediums as defined herein excludes signals, but such media or mediums may be capable of receiving and processing information from signals and/or other transitory mediums.

It will be readily understood that the components of the embodiments as generally described herein and illustrated in the appended figures could be arranged and designed in a wide variety of different configurations. Thus, the detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

What is claimed is:

1. A method for low-latency (LL) traffic frame communication between WLAN (wireless local area network) devices, comprising:
sending a trigger frame from an access point (AP) configured to allocate a random access resource unit (RA-RU) to a non-access point station (non-AP STA);
wherein the RA-RU enables the non-AP STA to transmit its low latency (LL) traffic information; and
receiving, from the non-AP STA, an uplink LL traffic frame using the RA-RU that was allocated.

2. The method of claim 1:
wherein the RA-RU is configured to be used only for uplink LL traffic frame transmission.

3. The method of claim 2:
wherein the RA-RU allocated is unavailable for non-LL traffic frames.

4. The method of claim 1:
further comprising, announcing, by the AP, the RA-RU periodic allocation in a broadcast management frame.

5. The method of claim 1, further comprising:
establishing, between the non-AP STA and the AP, a membership group by exchanging management frames;
wherein the membership group is associated with the RA-RU; and
transmitting, by the non-AP STA, a LL traffic frame on the RA-RUs assigned to the membership group.

6. The method of claim 1, further comprising:
transmitting, by the non-AP STA, an LL traffic frame by selecting the RA-RU without random backoff when the non-AP STA receives the trigger frame.

7. The method of claim 1:
wherein the trigger frame is an Uplink OFDMA Random Access (UORA) Mode random access trigger frame (TF-R).

8. The method of claim 1:
wherein the trigger frame is included in a MU PPDU downlink (DL) data frame.

9. The method of claim 1:
wherein the LL information includes an LL traffic frame.

10. The method of claim 1:
wherein the LL information includes a buffer status report frame including buffered LL traffic frames pending uplink.

11. The method of claim 1:
wherein the AP holds a transmission opportunity (TXOP).

12. The method of claim 1:
wherein the non-AP STA holds a transmission opportunity (TXOP).

13. The method of claim 12:
wherein the non-AP STA is a first non-AP STA;
further comprising,
receiving, by the AP, a Reverse Direction Grant (RDG) from the non-AP STA TXOP holder; and
sending the trigger frame from the access point (AP) to allocate the RA-RU to a second non-AP STA for LL traffic frame transmission.

14. The method of claim 12:
wherein the non-AP STA is a first non-AP STA;
wherein the AP has a TXOP preemption interval overlapping the TXOP held by the first non-AP STA; and
further comprising, sending the trigger frame from the access point (AP) to allocate the RA-RU to a second non-AP STA for LL traffic frame transmission.

15. The method of claim 1, further comprising:
defining a new Uplink OFDMA Random Access (UORA) parameter set for LL traffic frame transmissions that differs from standard UORA parameter sets.

16. The method of claim 1, further comprising:
defining a new Uplink OFDMA Random Access (UORA) backoff procedure for LL traffic frame transmissions that differs from standard UORA backoff procedures.

17. The method of claim 16:
wherein the new UORA backoff procedure prevents the non-AP STA from performing OFDMA random backoff, OBO count selection based on an OCW, and OBO count decrement based on a number of the RA-RUs allocated.

18. The method of claim 1, further comprising:
polling, by the AP, to check if the non-AP STA has any buffered LL traffic by sending an NFRP (NDP Feedback Report Poll) trigger frame to the non-AP STA that is specific to LL traffic frame transmissions.

19. The method of claim 1, further comprising:
receiving an LL Indication (LLI) frame, by the AP, from the non-AP STA; and
sending, by the AP, the trigger frame allocating the RA-RUs for the non-AP STA's LL traffic frame transmissions in response to receiving the LLI frame.

20. The method of claim 19:
wherein the non-AP STA is configured to send the LLI frame in response to receiving from the AP an LLI Allowance frame indicating that LLI frames are allowed.

21. A method for low-latency (LL) traffic frame communication between WLAN (wireless local area network) devices, comprising:
receiving a trigger frame from an access point (AP) configured to allocate a random access resource unit (RA-RU) to a non-access point station (non-AP STA);
wherein the RA-RU enables the non-AP STA to transmit its low latency (LL) traffic information;
transmitting, by the non-AP STA, an uplink LL traffic frame using the RA-RU that was allocated.

22. The method of claim 21:
wherein the RA-RU is configured to be used only for uplink LL traffic frame transmission.

23. The method of claim 21, further comprising:
announcing, by the AP, a periodic allocation of RA-RUs in a broadcast management frame.

24. The method of claim 21, further comprising:
establishing, between the non-AP STA and the AP, a membership group by exchanging management frames;
wherein the membership group is associated with the RA-RU; and
transmitting, by the non-AP STA, an LL traffic frame on the RA-RUs assigned to the membership group.

25. The method of claim 21, further comprising:
transmitting, by the non-AP STA, an LL traffic frame by selecting the RA-RU without random backoff when the non-AP STA receives the trigger frame.
